(19) United States
(12) Patent Application Publication
(10) Pub. No.: US 2009/0229136 A1
(43) Pub. Date: Sep. 17, 2009

(54) HANDS FREE LEVEL

(76) Inventor: Adrian Howard, Hertfordshire (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/402,231

(22) Filed: Mar. 11, 2009

Related U.S. Application Data
(60) Provisional application No. 61/037,142, filed on Mar. 17, 2008.

(51) Int. Cl. G01C 9/24; G01C 9/02

(52) U.S. Cl. 33/301; 33/371

(57) ABSTRACT

A level is provided, including a main body, at least one bubble vial and an arm. The main body includes at least one reference surface, a first clamping surface, and at least one aperture formed through the main body. The bubble vial is attached to the main body for indicating the orientation of the at least one reference surface. The arm projects through and slidable within the at least one aperture of the main body and includes a second clamping surface. An adjustable clamping distance is measured between the first clamping surface of the main body and the second clamping surface of the arm. The arm is slidable within the at least one aperture for adjusting the adjustable clamping distance.

### CROSS-REFERENCE TO RELATED APPLICATIONS

This application claims the benefit of U.S. Provisional Patent Application No. 61/037,142, filed on Mar. 17, 2008, the entire contents of which are hereby incorporated by reference.

### TECHNICAL FIELD

The present disclosure relates to levels, and in particular to levels for indicating the orientation of a reference surface.

### BACKGROUND

Typically, a level includes at least one bubble vial and at least one reference surface. The bubble vial indicates the orientation of the reference surface, where the bubble vial may include a slightly curved tube that is not completely filled with a fluid. Because the tube is not completely filled with fluid, a bubble is formed. Gravity will cause the bubble to rest at a midpoint of the tube when the reference surface is level to the earth.

The level may be utilized in a variety of applications, and in one instance a user may employ a level when attempting to perform a home improvement project. For example, a user may employ a level when assembling a flat-pack type of home furnishing, such as a shelving unit, a table, or the like. When assembling the home furnishing, one obstacle a user may encounter is mounting or assembling the product horizontally or vertically.

In one approach, the home furnishing may be mounted to a wall. The user may align the home furnishing to the wall and place a mark on the wall to indicate where at least one fixing point should be located. However, this process may be difficult and cumbersome for a user because of several reasons. In one example, the user may have to hold the home furnishing, a marking device and the level all at the same time in order to indicate the position of the fixing point on the wall. Holding the home furnishing, the marking device and the level all at the same time may prove to be difficult for at least some users. Moreover, holding all three objects at the same time increases the likelihood that the user may accidentally drop one of the objects.

Accordingly, there is a need for a level that may be directly affixed to the object to be leveled, while still allowing the level to be attached to the object with minimal effort.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 is a first perspective view of a first embodiment of a level;

FIG. 2 is a second perspective view of the level of FIG. 1;

FIG. 3 is a first perspective view of a second embodiment of a level;

FIG. 4 is a perspective view of the use of the level of FIG. 3 to level a shelf;

FIG. 4A is a perspective view of the level of FIG. 3 attached to a shelf;

FIG. 5 is a perspective view of the use of the level of FIG. 3 to level a book case;

FIG. 6 is a perspective view of the use of the level of FIG. 3 to level a curtain rod;

FIG. 7 is a perspective view of the level of FIG. 3 attached to a door;

FIG. 8A is a second perspective view of the level of FIG. 3;

FIG. 8B is a first side elevational view of the level of FIG. 3 on a surface to be leveled;

FIG. 8C is a second side elevational view of the level of FIG. 3 on a surface to be leveled;

FIG. 9A is front elevational view of the level of FIG. 3;

FIG. 9B is a cross-sectional view taken along the line A-A in FIG. 9A;

FIG. 9C is a detailed view of the ratcheting mechanism of the level of FIG. 9A;

FIG. 10 is a perspective view of a third embodiment of a level;

FIG. 11 is a perspective view of a fourth embodiment of a level;

FIG. 12 is a perspective view of a fifth embodiment of a level;

FIG. 13 is a partial perspective view of an embodiment of a sliding arm and projection for a level;

FIG. 14 is a partial perspective view of another embodiment of a sliding arm and projection for a level; and

FIG. 15 is a flow chart depicting a method of using a level.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, there are a number of constants introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

According to various exemplary illustrations described herein, a level is provided. The level includes a main body, at least one reference surface, at least one bubble vial and an arm. The main body includes the at least one reference surface, a first clamping surface and at least one aperture formed through the main body. The bubble vial is attached to the main body for indicating the orientation of the at least one reference surface. The arm projects through and is slidable within the at least one aperture of the main body. The arm also includes a second clamping surface. An adjustable clamping distance is included, and is measured between the first clamping surface of the main body and the second clamping surface of the arm. The arm is slidable within the at least one aperture for adjusting the adjustable clamping distance. The arm may also include a plurality of index locations for adjusting the adjustable clamping distance in predetermined increments. The arm may also further include a stop surface that is located generally opposite to the second clamping surface. The adjustable clamping distance may be measured along an axis, where the arm is slidable within the at least one aperture along the axis for adjusting the adjustable clamping distance.

A method of leveling an object is also disclosed. The method generally includes providing a level having a main body and an arm. The main body has at least one bubble vial and a first clamping surface, and the arm has a second clamping surface. The first clamping surface and the second clamping surface define an adjustable clamping distance between the first clamping surface and the second clamping surface. The method further includes grasping the main body with a single hand. The arm is urged through the main body with the single hand while continuing to grasp the main body to thereby adjust the adjustable clamping distance to accommodate the object. The object is interposed between the first clamping surface and the second clamping surface. The object is engaged with the first clamping surface and the second clamping surface. The orientation of the object is determined based on the position of a bubble in the bubble vial.

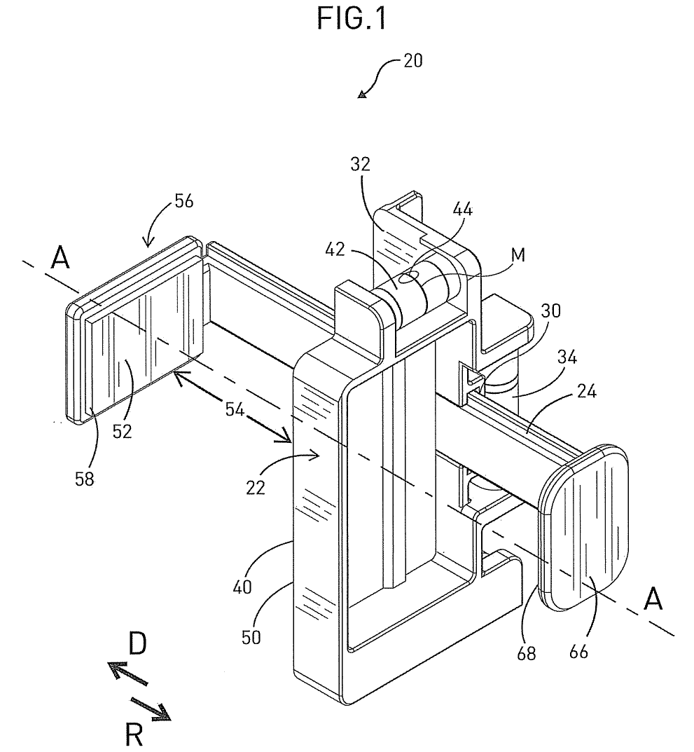

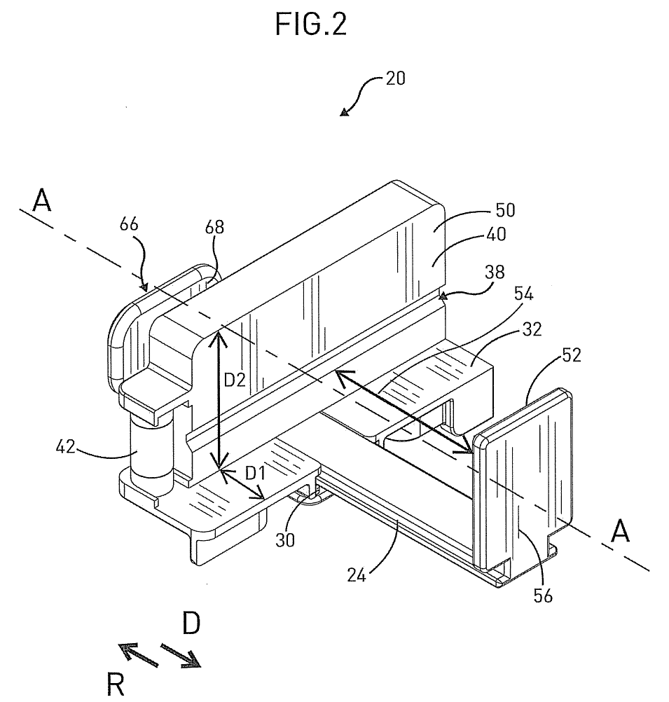

Turning now to the drawings and in particular to FIG. 1, an exemplary level 20 is disclosed. The level 20 includes a main body 22 and an arm 24, where the arm 24 projects through and is slidable within at least one aperture 30 that is included in the main body 22. FIG. 1 illustrates the arm 24 positioned generally perpendicular to the main body 22. The main body 22 includes at least one reference surface and at least one bubble vial, which are respectively illustrated as a first reference surface 32 (seen in FIG. 2) and a first bubble vial 34. The first bubble vial 34 indicates orientation of the first reference surface 32 with respect to the earth. More specifically, the bubble vial 34 includes a bubble 44, where gravity will cause the bubble 44 to rest at about midpoint M of the bubble vial 34 when the first reference surface 32 is level.

In the illustration as shown in FIG. 2, the main body 22 also includes a second reference surface 40. FIGS. 1-2 illustrate a second bubble vial 42, where the second bubble vial 42 indicates orientation of the second reference surface 40 with respect to the earth. The second reference surface 40 may be oriented generally perpendicular to the first reference surface 32. The main body 22 and the arm 24 may be constructed from a lightweight, low cost material such as, but not limited to, wood, plastic or metal. Moreover, the main body 22 and the arm may be constructed from a light-colored material to enhance visibility of the first and second bubble vials 34 and 42.

The arm 24 includes a second clamping surface 52, and as best seen in FIG. 2, the main body 22 includes a first clamping surface 50. As seen in FIGS. 1-2, the first clamping surface 50 and the second clamping surface 52 define an adjustable clamping distance 54, where the adjustable clamping distance 54 is measured between the first clamping surface 50 and the second clamping surface 52. The arm 24 is slidable within the aperture 30 for varying the adjustable clamping distance 54. More specifically, the adjustable clamping distance 54 is measured along an axis A-A, where the arm 24 is slidable within the aperture 30 along the axis A-A. Movement of the arm 24 along the axis A-A varies the adjustable clamping distance 54. As discussed in greater detail below, the first clamping surface 50 of the main body 22 and the second clamping surface 52 of the arm 24 cooperate together to form a clamping jaw 62 (not separately shown in the figures).

FIG. 1 illustrates the second clamping surface 52 included along a first projection 56 of the arm 24, where the first projection 56 limits sliding of the arm 24 in the aperture 30. That is, the arm 24 is retained in the aperture 30 when the arm 24 is urged in a direction R, towards the first clamping surface 50. Moreover, the first projection 56 may be lined with a compressible pad 58 that aids in retaining an object between the first clamping surface 50 and the second clamping surface 52. The compressible pad 58 may be constructed from any resilient material, such as, but not limited to, foam, rubber or a thermoplastic elastomer. The first and second clamping surfaces 50 and 52 are configured for attaching to a variety of different types of surfaces. In one example, the first and second clamping surfaces 50 and 52 are attachable to a variety of flat surfaces, including without limitation, those that are porous, non-porous, smooth, rough, magnetic or non-magnetic. In another example, the first and second clamping surfaces 50 and 52 may be non-magnetic. That is, the first and second clamping surfaces 50 and 52 are a mechanical interface, and therefore the clamping jaw 62 is configured to receive both magnetic and non-magnetic materials.

As discussed in greater detail below, the arm 24 may include a plurality of index locations that are for adjusting the adjustable clamping distance 54 measured between the first clamping surface 50 to the second clamping surface 52 at predetermined increments. The arm 24 also includes a stopper 66, and a stop surface 68 that is located generally opposite to and faces the main body 22 and the second clamping surface 52. The adjustable clamping distance 54 may be varied by advancing or retracting the stop surface 68 from the main body 22 in predetermined increments. The stopper 66 limits sliding of the arm 24 in the aperture 30. More specifically, the arm 24 is limited in movement by the stopper 66 when urged in a direction D.

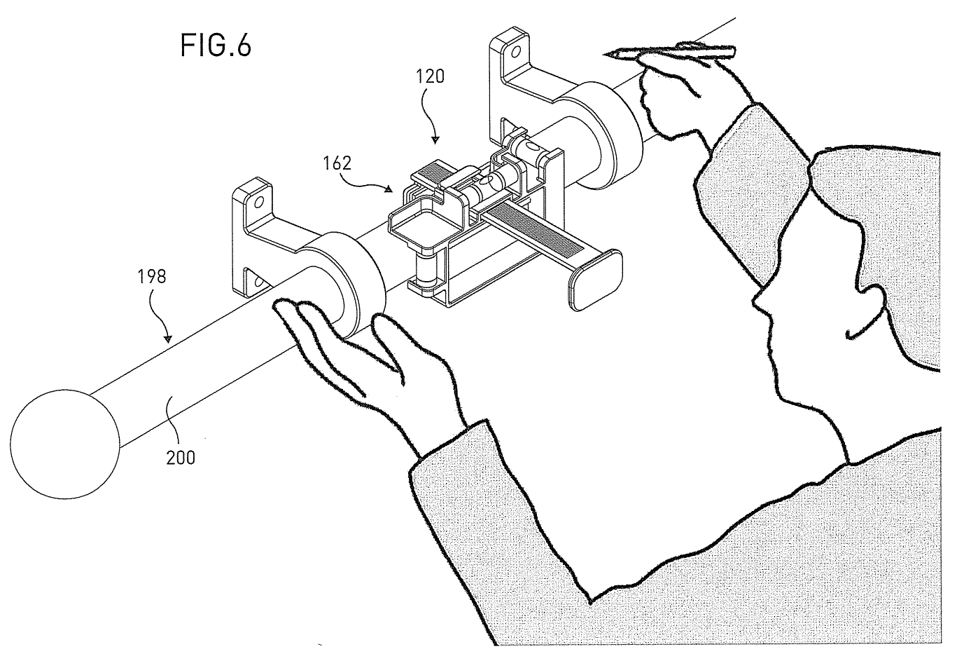

As seen in FIG. 2, the first clamping surface 50 may include a tube groove 38. The tube groove 38 is located opposite the second clamping surface 52, and allows for the clamping jaw 62 to be secured to a circular cross section, or a curved surface. For example, as discussed below, FIG. 6 illustrates an alternative illustration of the level 20 being clamped to a curtain rod with a circular cross section.

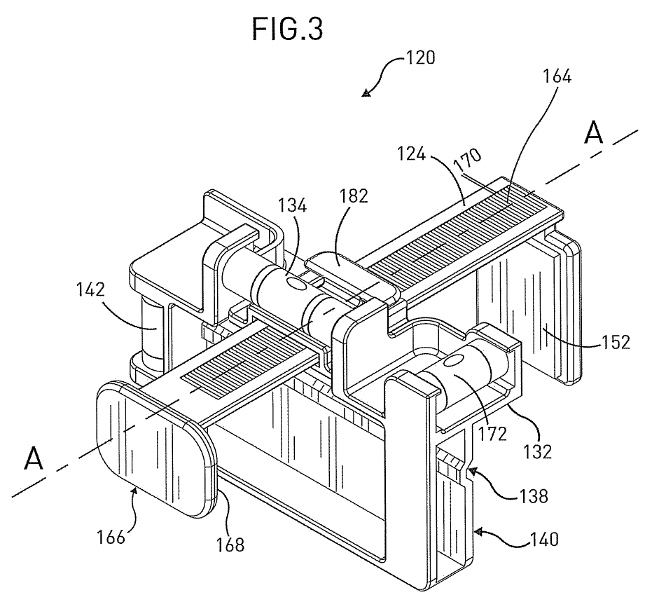

FIG. 3 depicts an alternate embodiment of a level. Portions of the depicted level which correspond to the components of level 20 of FIG. 1 are identified using the same reference numerals as are used for FIG. 1 with a preceding “1.” Thus, the level of FIG. 2 is level 120. A similar convention is used with respect to other level embodiments 220, 320, and 420, as will be described in greater detail below.

Referring to FIG. 3, level 120 has an arm 124 with a structure that provides indexed movement with respect to main body 122. The arm 124 may also include a different length, thickness or strength, depending on the type of object that is to be leveled. In one example, the arm 124 may include a different length than the arm 24, but may still be utilized within the same main body 22 as seen in FIGS. 1-2. In the illustration as shown in FIG. 3, the arm 124 includes a series of index locations 164 that have predetermined increments 170 spaced apart along the length of arm 124.

FIG. 3 also illustrates a third bubble vial 172 as well, where the third bubble vial 172 is another indicator of both of the first reference surface 132 and the second reference surface 140. That is, because three bubble vials are included with the level 120, if one of the first and second bubble vials 134 and 142 are not within easy viewing distance, the third bubble vial 172 may be used instead. In the illustration as shown in FIG. 3, the second reference surface 140 may be oriented generally perpendicular to the first reference surface 132.

As best seen in FIG. 2, the first reference surface 32 and the second reference surface 40 include an overall depth, where the depth of the first reference surface 32 is less than the depth of the corresponding second reference surface 40. More specifically, as seen in FIG. 2, the first reference surface 32 includes a first depth D1, and the second reference surface includes a second depth D2. As illustrated, the first depth D1 is less than the second depth D2. Thus, because the second depth D2 is greater than the first depth D1, the first depth D2 provides a more accurate indication of leveling when the level 20 is clamped to an object. This is because the second reference surface 40 can be attached to a thicker surface. As discussed in greater detail below, because the second depth D2 is greater than the first depth D1, the first reference surface 32 may be used to attach to an object with a shallower surface.

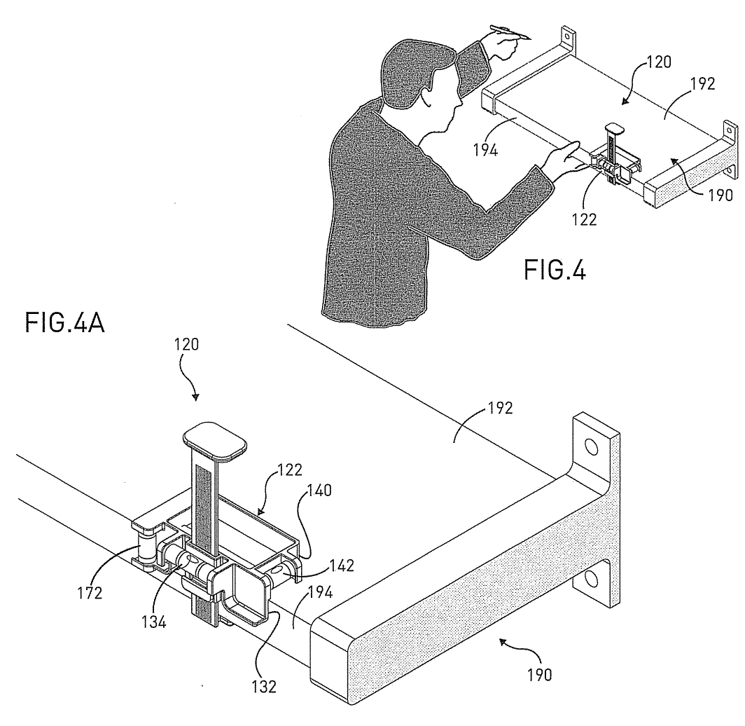

FIG. 4 illustrates a user mounting the level 120 to an object, illustrated as a shelf 190. As seen in FIGS. 4, 4A, 5, 6 and 7, the level 120 of FIG. 3 is configured to attach directly to the object that is to be leveled. This is advantageous because if a user desires to change the location of the object to be leveled, the level 120 need not be adjusted. It should be noted that while FIGS. 4 and 4A illustrate a shelf, the level may be mounted to any object that can be hung on a wall or that needs leveling, such as, but not limited to, a picture frame, a bookcase or a table.

As best seen in FIG. 4A, the shelf 190 includes a shelving surface 192 and a side surface 194. The side surface 194 is thinner and shallower than the shelving surface 192. The first reference surface 132 is configured for indicating the orientation of the shelf 190, and is done by aligning the first reference surface 132 located along the main body 122 with the side surface 194. Indeed, the first reference surface 132 includes a smaller depth than the second reference surface 140 (as illustrated in FIG. 2), and therefore can be more readily attached to a shallower surface, such as the shelving surface 192.

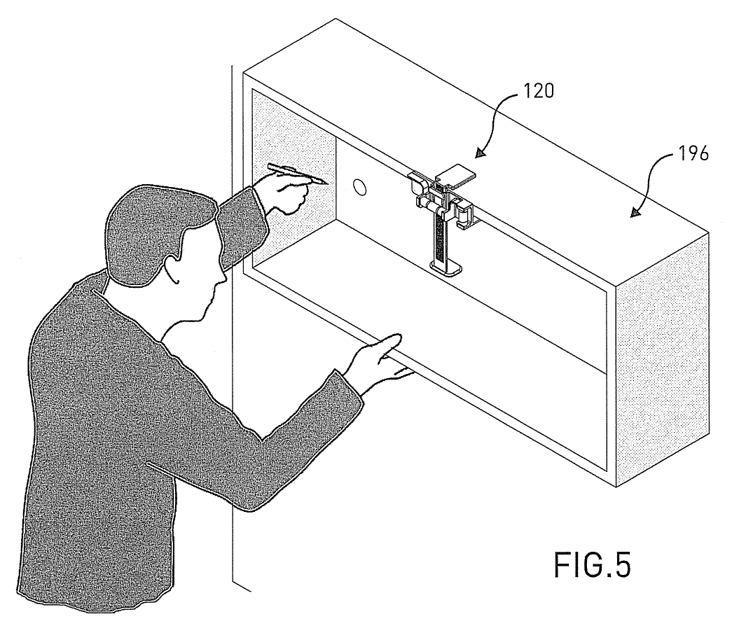

The second reference surface 140 is aligned with the shelving surface 192. The shelving surface 192 includes a depth that is greater than the side surface 194. In the illustration as seen in FIG. 4A, the third bubble vial 172 does not indicate the orientation of either the first and second reference surfaces 132 and 140, and instead the bubble floats to the top of the vial and can not be seen. Instead, the first and second bubble vials 134 and 142 indicate the orientation of the shelf 190. When any of the first second or third bubble vials 132, 140 or 172 are upright, the bubble inside floats to the top portion of the vial and does not indicate orientation. It should be noted that the level 120 may be used to level a variety of different objects, and may be also clamped to the objects in a variety of different orientations. For example, as seen in FIG. 5, the level 120 is clamped to a shelving unit 196. Moreover, the level 120 is clamped to the shelving unit 196 in an orientation that is opposite to the orientation as seen in FIGS. 4 and 4A.

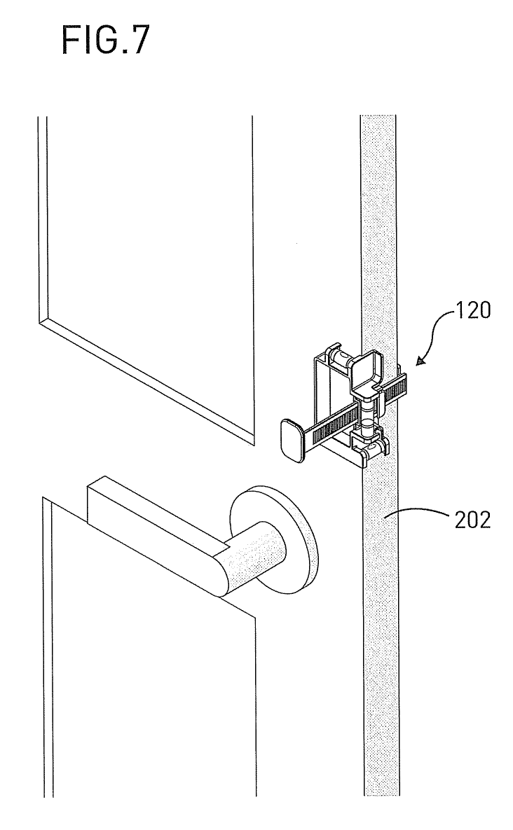

It should be noted that the level 120 is also capable of clamping to a curved surface. For example, as seen in FIG. 6, the level 120 is clamped to a curtain rod 198. The curtain rod 198 includes a curved outer surface 200. As discussed above, the tube groove 138 (not illustrated in FIG. 6) allows for the clamping jaw 162 to be secured to a circular cross section. The level 120 is clamped to the curved outer surface 200 of the curtain rod 198. Because the level 120 includes the adjustable arm 124, the level 120 may be clamped to a variety of objects and surfaces that vary in thickness. Indeed, in another example as seen in FIG. 7, the level 120 may be clamped to a door 202.

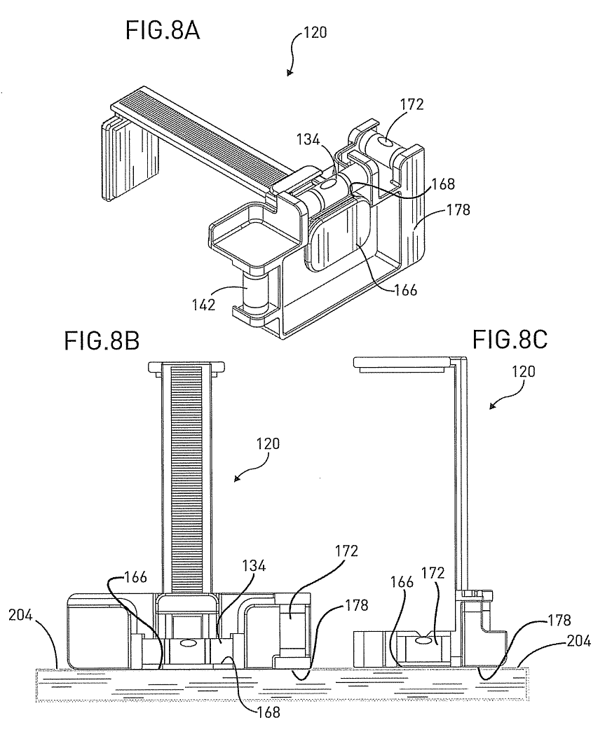

The level 120 may also be used as a stand alone leveling device that is not clamped to any object. That is, as seen in each of FIGS. 8A, 8B and 8C, the level may also include a stand alone surface 178. The level 120 is not clamped to any object or surface. FIG. 8B illustrates the first bubble vial 134 indicating the orientation of the surface 204, and the stand alone surface 178 lying across the surface 204. It should be noted that when the level 120 is used as a stand alone device, the stopper 166 and the stop surface 168 are recessed from the stand alone surface 178 so that the surface of stopper 166 opposite stop surface 168 and stand alone surface 178 are substantially coplanar.

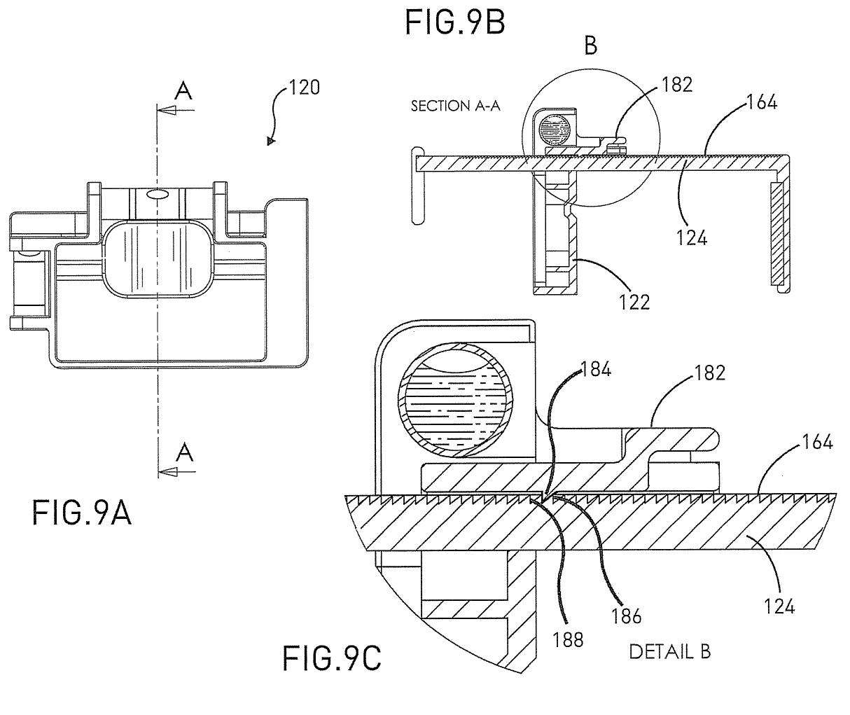

Referring back to FIG. 3, the main body 122 includes a ratchet bar catch 182. The ratchet bar catch 182 is configured for engagement with the index locations 164 that are located along the arm 124. As best seen in FIGS. 9B and 9C, the ratchet bar catch 182 is configured to engage with the index locations 164 to retain and secure the arm 124 in a desired location. FIG. 9A is a frontal view of the level 120, where the level 120 is sectioned along line A-A. FIG. 9B illustrates a cross sectional view of the arm 124 as well as the ratchet bar catch 182. FIG. 9C is an enlarged, detailed view of FIG. 9B.

As best seen in FIG. 9C, the ratchet bar catch 182 includes an index point 184. An outer profile 186 of the index point 184 is configured to mate with an outer profile 188 of the index locations 164. Thus, as may be seen, the outer profile 186 of the index point 184 engages and secures the outer profile 188 of one of the index locations 164, thereby securing the arm 124 in place. Engagement of the outer profile 186 of the index point 184 and the outer profile 188 of the index locations 164 will lock the arm 124 into position. The index point 184 and the index location 164 may be disengaged when a user lifts the index point 184, thereby causing the outer profile 186 of the index point to lift away from the index location 164.

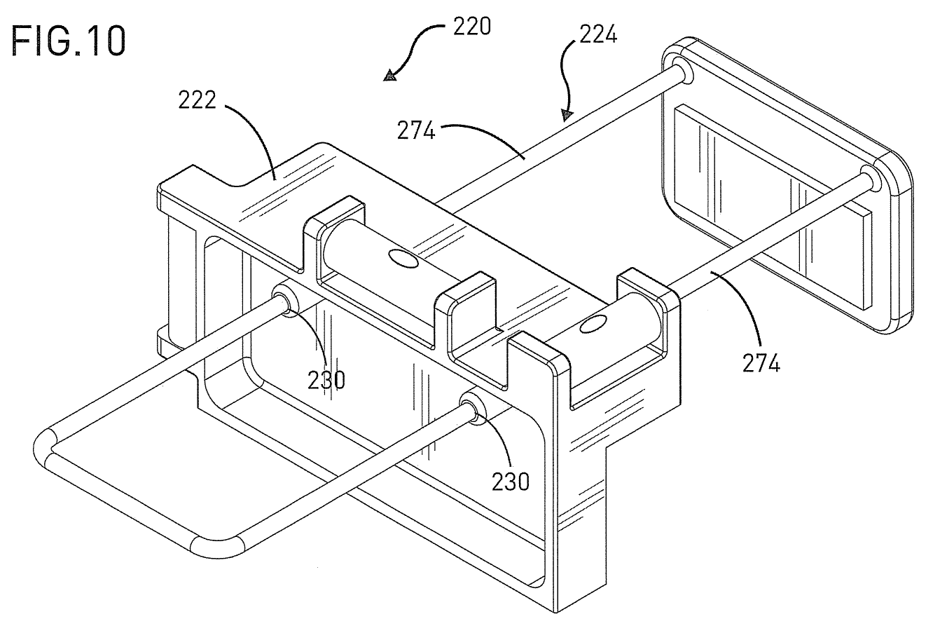

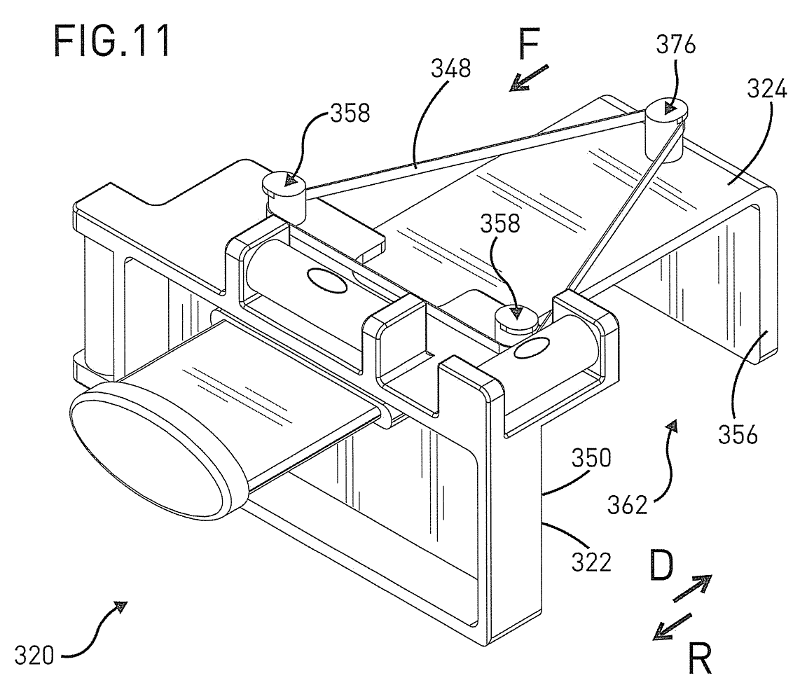

In one alternative illustration as seen in FIG. 10, the arm 224 includes two lateral sections 274 that are received by two apertures 230 that are included in the main body 222. In yet another illustration as seen in FIG. 11, the arm 324 may be spring loaded by a tensioning belt 348 that is in communication with a series of posts. The main body 322 includes a pair of posts 358 that retain the tensioning belt 348 at the main body 322, and the arm 324 also includes at least one post 376 that retains the tensioning belt 348 at the arm 324. As the arm 324 is advanced away from the body 322 and in the direction D, the tensioning belt 348 exerts a force F that urges the first projection 356 of the arm 324 towards the first clamping surface 350. Thus, the clamping jaw 362 exerts the force F on an object when the level 320 is used to clamp an object. It should be noted that while the level 320 does not include index points, the tensioning belt 348 is adjustable, and can retain the first projection 356 of the arm 324 at a predetermined, desired location instead. Thus, the index points may be omitted from this illustration if desired.

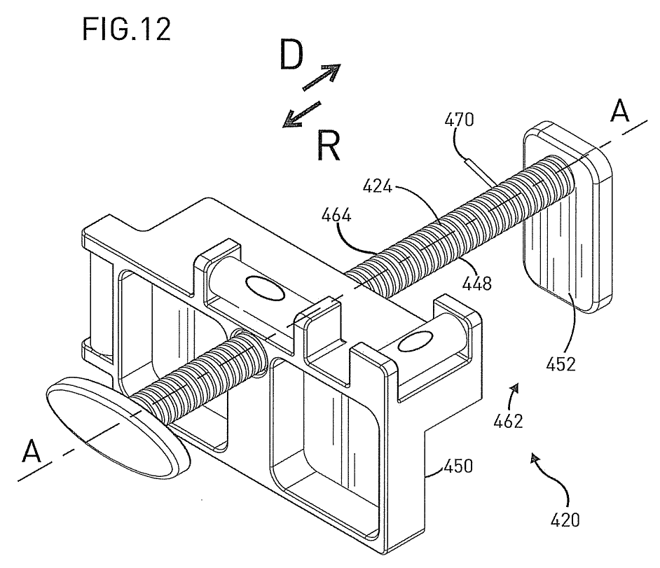

In another illustration as seen in FIG. 12, the arm 424 may include a threaded screw portion 448 that is the series of index locations 464 adjusting the second clamping surface 452 at predetermined increments 470. The arm 424 is rotated about the axis A-A to advance the arm 424 in the direction R towards the first clamping surface 450. Alternatively, the arm 424 may be rotated in the opposite direction D, and away from the first clamping surface 450 to release an object that is engaged with the clamping jaw 462.

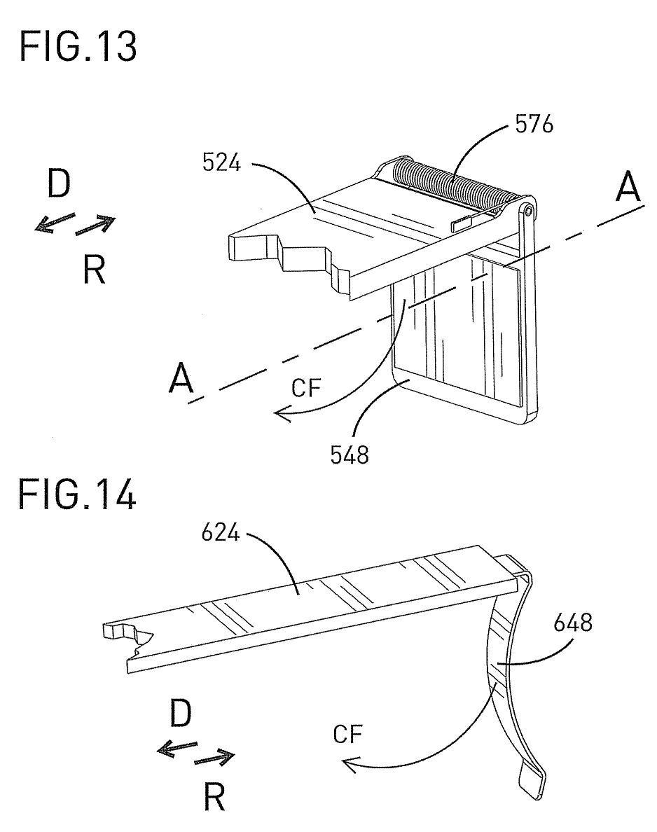

In yet another alternative illustration, the first projection 556 may be a spring-loaded device. More specifically, as seen in FIG. 13, the arm may include a hinged end 548, where the hinged end 548 is spring loaded for securing an object in the clamping jaw (not shown in FIG. 13). In the illustration as shown, the hinged end 548 includes a torsion spring 576 for exerting a clamping force CF along the axis A-A, and in the direction D. In the alternative illustration of FIG. 14, the hinged end 648 may not include the torsion spring 576, and instead the hinged end 648 is biased for exerting the clamping force CF in the direction D.

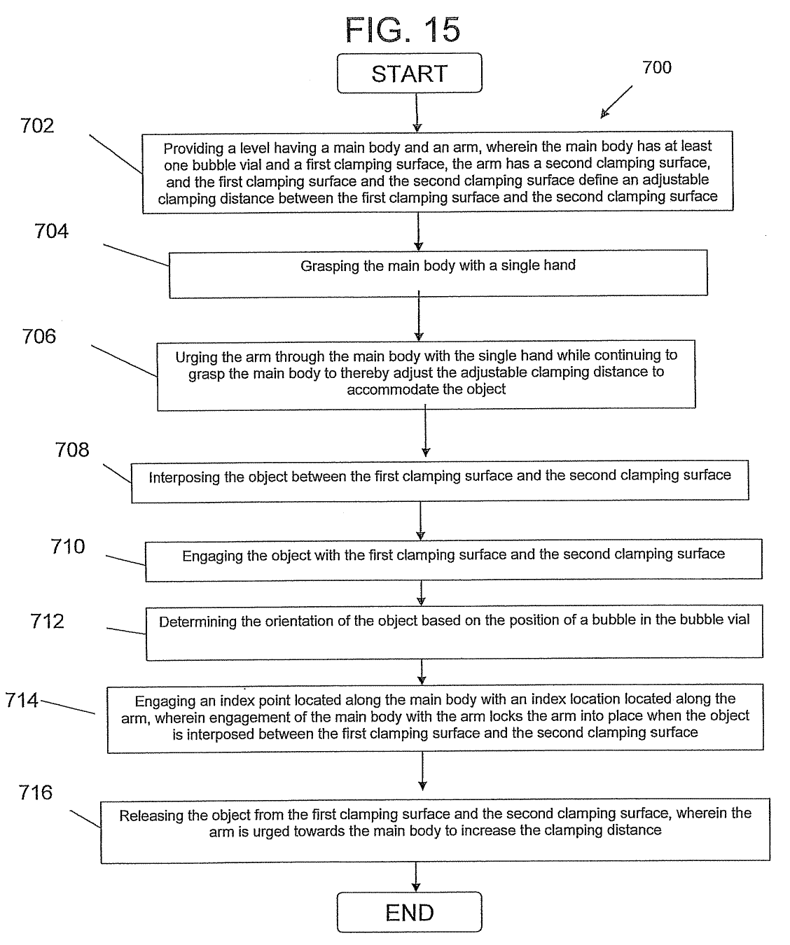

An exemplary method of using level 20 will now be described. Although the method is illustrated with level 20, the other types of levels described herein may also be used with the method. One advantage of the level 20 is that the level 20 may be grasped with only one hand of a user to actuate the clamping jaw 62. Being able to grasp the level with only one hand is advantageous, because the user is able to use the other hand for performing another task. Use of the level 20 is illustrated as process 700, a method of leveling an object, and is illustrated generally in FIG. 15. In step 702, the level 20 is provided, having the main body 22 and the arm 24. As discussed above, the main body 22 has at least one bubble vial, such as the first bubble vial 34 and a first clamping surface 50. The arm 24 has the second clamping surface 52, and the first clamping surface 50 and the second clamping surface 52 define the adjustable clamping distance 54. The adjustable clamping distance 54 is measured between the first clamping surface 50 and the second clamping surface 52.

Referring to the exemplary level 120 of FIG. 3, in one illustrative method, the user adjusts the adjustable clamping distance 154 to accommodate the item (e.g., door, bookcase, shelf, etc.) to which level 120 will be clamped. The user then grips level 120 in one hand by resting the thumb of one hand on level surface 178 (FIG. 8A) and the fingers of the same hand on the side of first projection 156 that is opposite the second clamping surface 152. The level 120 is then positioned with the item to be clamped disposed between the first clamping surface 150 and second clamping surface 152 while keeping the hand in place. The second clamping surface 152 is then adjusted toward the first clamping surface 150 by squeezing the surfaces together with the same hand until the level 120 is securely clamped to the item. The engagement of ratchet bar catch 182 and index locations 164 retains level 120 in place. After the item is leveled, ratchet bar catch 182 is manipulated to remove the engaged index point 184 from the index locations 164. The adjustable clamping distance 154 is then increased sufficient to remove level 120 from the clamped item.

In step 704, the main body 22 is grasped with a single hand. As discussed above, one advantage of the level 22 is that a user able to grasp the level 22 with only one hand, allowing the user to use the other hand for performing another task.

In step 706, the arm 22 is urged though the main body 22 with the single hand. At the same time, the single hand continues to grasp the main body 22 to thereby adjust the adjustable clamping distance 54 to accommodate the object. As discussed above, the object may be any structure that a user desires to level, such as the shelf 190. The clamping distance 54 is adjusted to be large enough to accommodate the object to which the level 20 is attached.

In step 708, the object is interposed between the first clamping surface 50 and the second clamping surface 52. For example, as discussed above, the object could be a variety of structures, such as, but not limited to, a shelf, a curtain rod, or a shelf. Indeed, the object may be any structure that a user desires to level.

In step 710, the object is engaged with the first clamping surface 50 and the second clamping surface 52. For example, as discussed above, the object could be any structure that a user desires to level, such as the shelf 190, that includes the shelving surface 192 and the side surface 194.

In step 712, the object is oriented by determining the position of a bubble in the bubble vial, such as the bubble vial 34. For example, as discussed above, gravity will cause the bubble 44 to rest at the midpoint M of the bubble vial 34 when the first reference surface 32 is level to the earth.

In certain illustrative methods, level 120 is configured for indexed adjustment of the arm 124 with respect to the main body 122. In these methods, illustrated as step 714, the index point 184 located along the main body 122 is engaged with the index location 164 located along the arm 124 (as seen in FIGS. 9A and 9B). Engagement of the main body 122 with the arm 124 locks the arm 124 into place when the object is interposed between the first clamping surface 150 and the second clamping surface 152. For example, as discussed above, the main body 122 includes the ratchet bar catch 182. The ratchet bar catch 182 is configured for engagement with the arm 124. More specifically, the ratchet bar catch 182 is configured to engage with the index locations 164 and secure the arm 124 in a desired location.

In step 716, the object that is interposed between the first clamping surface 50 and the second clamping surface 52 is released. The object is released by urging the arm 24 towards the main body 22, and increasing the adjustable clamping distance 54. In the illustration as shown in FIGS. 9A, 9B and 9C, the level 120 includes the ratchet bar catch 182. As discussed above, the index point 184 and the index location 164 may be disengaged when a user lifts the index point 184, thereby causing the outer profile 186 of the index point to lift away from the index location 164. After the ratchet bar catch 182 is lifted, the arm 124 may be urged towards the main body 122. The object may be any object that can be hung on a wall or that needs leveling, such as, but not limited to, a shelf, a shelving unit, a curtain rod, a door, a picture frame or a table. The level 20 may be grasped with only one hand in order to release the object. Process 700 may then terminate.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

What is claimed is:

1. A level, comprising:
a main body including at least one reference surface, a first clamping surface, and at least one aperture formed through the main body;
at least one bubble vial attached to the main body for indicating the orientation of the at least one reference surface;
an arm projecting through and slidable within the at least one aperture of the main body and including a second clamping surface; and
an adjustable clamping distance measured between the first clamping surface of the main body and the second clamping surface of the arm;
wherein the arm is slidable within the at least one aperture for adjusting the adjustable clamping distance.

2. The level as recited in claim 1, wherein the arm includes a plurality of index locations for adjusting the adjustable clamping distance in predetermined increments.

3. The level as recited in claim 1, wherein the arm further comprises a stop surface that is located generally opposite to the second clamping surface.

4. The level as recited in claim 3, wherein the adjustable clamping distance is varied by advancing or retracting the stop surface from the main body.

5. The level as recited in claim 1, wherein the first clamping surface and the second clamping surface are attachable to both of smooth and rough surfaces.

6. The level as recited in claim 1, wherein the first clamping surface and the second clamping surfaces are non-magnetic.

7. The level as recited in claim 1, wherein the main body includes a second reference surface and a second bubble vial, wherein the second reference surface is generally perpendicular to the at least one reference surface, and the second bubble vial indicates the orientation of the second reference surface.

8. The level as recited in claim 7, wherein the first reference surface and the second reference surface include an overall depth, the depth of the second reference surface is greater than the depth of the first reference surface.

9. The level as recited in claim 1, wherein the adjustable clamping distance is measured along an axis, and the arm is slidable within the at least one aperture along the axis for varying the adjustable clamping distance.

10. A level, comprising:
a main body including at least one reference surface, a first clamping surface, and an aperture formed through the main body;
at least one bubble vial attached to the main body for indicating the orientation of the at least one reference surface;
an arm having an axis and projecting through and slidable along the axis and within the at least one aperture of the main body, the arm including a second clamping surface and a stop surface, wherein the stop surface is located generally opposite to the second clamping surface; and
an adjustable clamping distance measured along the axis between the first clamping surface of the main body and the second clamping surface of the arm, the arm being slidable along the axis for adjusting the adjustable clamping distance;
wherein the adjustable clamping distance is varied by advancing or retracting the stop surface from the main body;
wherein the first clamping surface of the body and the second clamping surface of the arm cooperate to form a clamping jaw.

11. A method of leveling an object, comprising:
providing a level having a main body and an arm, wherein the main body has at least one bubble vial and a first clamping surface, the arm has a second clamping surface, and the first clamping surface and the second clamping surface define an adjustable clamping distance between the first clamping surface and the second clamping surface;
grasping the main body with a single hand;
urging the arm through the main body with the single hand while continuing to grasp the main body to thereby adjust the adjustable clamping distance to accommodate the object;
interposing the object between the first clamping surface and the second clamping surface;
engaging the object with the first clamping surface and the second clamping surface; and
determining the orientation of the object based on the position of a bubble in the bubble vial.

12. The method as recited in claim 11, further comprising the step of engaging an index point located along the main body with an index location located along the arm, wherein engagement of the main body with the arm locks the arm into place when the object is interposed between the first clamping surface and the second clamping surface.

13. The method as recited in claim 11, further comprising the step of releasing the object from the first clamping surface and the second clamping surface, wherein the arm is urged towards the main body to increase the adjustable clamping distance.
